(19) United States
(12) Patent Application Publication
(10) Pub. No.: US 2016/0111133 A1
(43) Pub. Date: Apr. 21, 2016

(54) RADIO COMMUNICATION DEVICE

(71) Applicant: JVC KENWOOD CORPORATION, Yokohama-shi (JP)

(72) Inventor: Kazuomi TACHIGI, Yokohama-shi (JP)

(21) Appl. No.: 14/872,694

(22) Filed: Oct. 1, 2015

(30) Foreign Application Priority Data
Oct. 17, 2014 (JP) 2014-212222

(51) Int. Cl. G11B 31/00; G11B 27/031

(52) U.S. Cl. CPC G11B 31/003; G11B 27/031

(57) ABSTRACT

A reception unit is configured to demodulate a received audio signal from a received signal. A first detector is configured to detect that a state of the received signal has changed when the reception unit receives a signal transmitted wirelessly from a distant station. A first chapter generator is configured to generate a first chapter when the first detector has detected that the state of the received signal has changed. The first chapter indicates timing when the state of the received signal has changed. A recording data generator is configured to convert the received audio signal into voice data with a predetermined format, add the first chapter to the voice data, and generate recording data with a predetermined format. A recording controller is configured to control to record the recording data in a recording medium.

### CROSS REFERENCE TO RELATED APPLICATION

This application is based upon and claims the benefit of priority under 35U.S.C. §119 from Japanese Patent Application No. 2014-212222, filed on Oct. 17, 2014, the entire contents of which are incorporated herein by reference.

### BACKGROUND

The present disclosure relates to a radio communication device having the function of recording and reproducing a received audio signal.

There is a radio communication device having a function of recording and reproducing a received audio signal. This type of radio communication device can perform fast forward, fast rewind and skip a predetermined distance at the time of reproducing the recorded audio signal. In the case where the audio signal is recorded as a plurality of audio files, the radio communication device can select an audio file to be reproduced.

### SUMMARY

For example, in the case where an audio signal of several hours or more can be recorded as one audio file, it is not easy to cue a predetermined position of the audio signal. If a predetermined position is attempted to be cued by using the fast forward, the fast rewind and the skip functions, then these operations must be performed many times, and considerable man-hours and time are required.

An aspect of the embodiments provides a radio communication device including: a reception unit configured to demodulate a received audio signal from a received signal; a first detector configured to detect that a state of the received signal has changed when the reception unit receives a signal transmitted wirelessly from a distant station; a first chapter generator configured to generate a first chapter when the first detector has detected that the state of the received signal has changed, the first chapter indicating timing when the state of the received signal has changed; a recording data generator configured to convert the received audio signal into voice data with a predetermined format, add the first chapter to the voice data, and generate recording data with a predetermined format; and a recording controller configured to control to record the recording data in a recording medium.

### BRIEF DESCRIPTION OF THE DRAWINGS

FIG. 1 is a block diagram showing an entire configuration of a radio communication device of at least one embodiment.

FIG. 2 is a block diagram showing a specific internal configuration example of a controller 1 in FIG. 1.

FIG. 3 is a diagram conceptually showing a correspondence relationship between a state of squelch and squelch chapters added to voice data.

FIG. 4 is a flowchart showing processing for allowing the controller 1 to add the squelch chapters to the voice data.

FIG. 5 is a diagram conceptually showing a correspondence relationship between a state of an S meter level and S meter chapters.

FIG. 6 is a flowchart showing processing for allowing the controller 1 to add the S meter chapters to the voice data.

FIG. 7 is a diagram conceptually showing call sign chapters to be added to the voice data by the controller 1.

FIG. 8 is a flowchart showing processing for allowing the controller 1 to add the call sign chapters to the voice data.

FIG. 9 is a diagram conceptually showing signaling chapters to be added to the voice data by the controller 1.

FIG. 10 is a flowchart showing processing for allowing the controller 1 to add the signaling chapters to the voice data.

FIG. 11 is a diagram conceptually showing position information chapters to be added to the voice data by the controller 1.

FIG. 12A is a first partial flowchart showing processing for allowing the controller 1 to add the position information chapters to the voice data.

FIG. 12B is a second partial flowchart showing processing for allowing the controller 1 to add the position information chapters to the voice data.

FIG. 12C is a third partial flowchart showing processing for allowing the controller 1 to add the position information chapters to the voice data.

FIG. 13 is a diagram conceptually showing transmission chapters to be added to the voice data by the controller 1.

FIG. 14 is a flowchart showing processing for allowing the controller 1 to add the transmission chapters to the voice data.

FIG. 15 is a view showing an example of an operation setting menu image to be displayed on a display in order to set operations of the radio communication device of the embodiment.

FIG. 16 is a table showing a format of a list chunk in a WAVE file.

FIG. 17 is a table showing an example of chapter data included in the list chunk shown in FIG. 16.

FIG. 18 is a diagram showing a specific example of the list chunk.

FIG. 19 is a flowchart showing processing for reading information regarding the chapters from the list chunk of the WAVE files.

FIG. 20 is a flowchart showing specific processing of steps S1907 to S1912 in FIG. 19.

FIG. 21 is a flowchart showing specific processing of step S1913 in FIG. 19.

FIG. 22 is a flowchart showing specific processing of step S1914 in FIG. 19.

FIG. 23 is a flowchart showing processing for selecting the chapter and cueing a predetermined position of the voice data.

FIG. 24 is a table showing an example of a chapter selection image to be displayed in order to select the chapter.

### DETAILED DESCRIPTION

A description is made below of a radio communication device of at least one embodiment with reference to the accompanying drawings. First, a description is made of the entire configuration and operation of the radio communication device 100 of the embodiment.

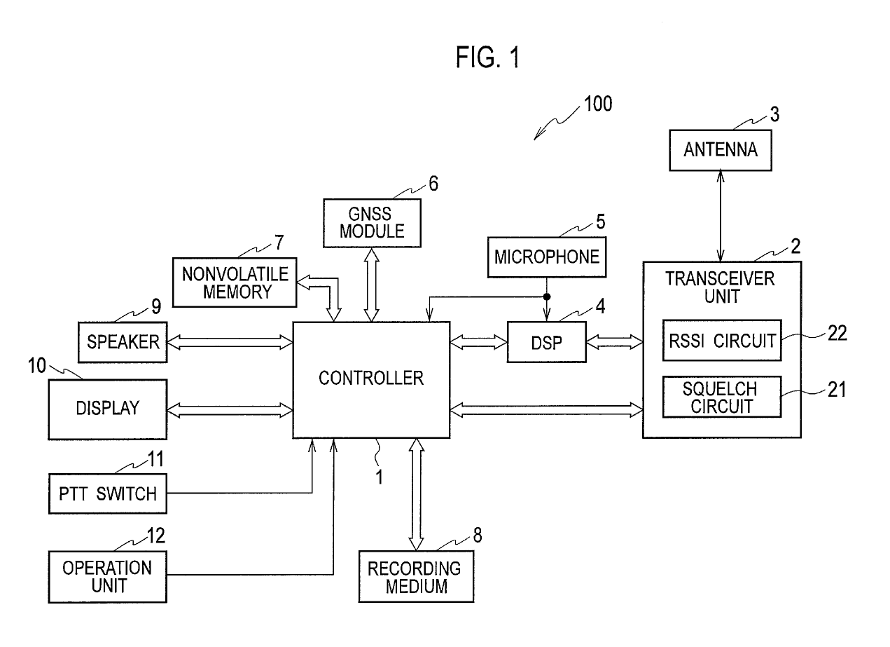

In FIG. 1, a controller 1 controls the whole of the radio communication device 100. The controller 1 can be composed of a microcomputer or a CPU. A transceiver unit 2 is connected to the controller 1. An antenna 3 for transmitting/receiving a radio wave is connected to the transceiver unit 2.

The transceiver unit 2 is a circuit block in which a transmission unit and a reception unit are configured integrally with each other. The transmission unit and the reception unit may be configured separately.

The transceiver unit 2 transmits or receives an audio signal between one person's radio communication device 100 (subject station) and another person's radio communication device (distant station) by a half-duplex communication method. A modulation method may be analog modulation or digital modulation. In the embodiment, a case where the transceiver unit 2 transmits/receives a digital modulation signal is exemplified.

Moreover, control data and a variety of additional information, other than the audio signal, may be included in the digital modulation signal or analog modulation signal, which are transmitted/received between the subject station and the distant station.

A DSP (digital signal processor) 4 is provided between the controller 1 and the transceiver unit 2. The DSP 4 encodes an analog audio signal, which is to be transmitted, into digital data, and then outputs the encoded digital data to the transceiver unit 2. The DSP 4 decodes a received digital signal obtained by demodulating the digital modulation signal received by the transceiver unit 2, and then converts the decoded digital signal into an analog audio signal.

In the case where a reception signal thus received is the digital modulation signal, the transceiver unit 2 demodulates the digital modulation signal, and outputs the received digital data thus demodulated to the DSP 4. From the received digital data, the DSP 4 decodes the control data and the variety of additional information, and outputs the decoded data to the controller 1. The DSP 4 decodes the voice data, performs D/A conversion, and outputs the converted voice data as an audio signal to the controller 1.

The transceiver unit 2 may receive position information for the distant station as the additional information. The transceiver unit 2 and the DSP 4 are position information acquisition units which acquire the position information for the distant station.

A microphone 5 is connected to the DSP 4. The microphone 5 picks up a voice emitted by a user of the radio communication device 100, converts the voice into an audio signal, and supplies the audio signal to the DSP 4. The audio signal outputted from the microphone 5 is also inputted to the controller 1.

The DSP 4 performs A/D conversion for the audio signal inputted thereto, further encodes the audio signal into transmission digital data, and modulates the transmission digital data in order to transmit the transmission digital data as the digital modulation signal in the transceiver unit 2.

In a case where the transceiver unit 2 transmits the analog audio signal, the audio signal inputted from the microphone 5 just needs to be supplied to the transceiver unit 2.

In a case where the transceiver unit 2 receives the analog audio signal, the transceiver unit 2 demodulates the analog audio signal into an audio signal. Hence, the DSP 4 detects the control data and the additional information, which will be described later, from the demodulated audio signal, performs a frequency limitation for a demodulation band, and outputs the audio signal to the controller 1. The controller 1 allows a speaker 9 to output the demodulated voice.

The transceiver unit 2 includes a squelch circuit 21 and an RSSI (received signal strength indication) circuit 22. The squelch circuit 21 extracts a noise component from a wave detection signal obtained by detecting the reception signal, and outputs a squelch voltage corresponding to the level of the noise component. The RSSI circuit 22 measures the intensity of the reception signal, and outputs an RSSI voltage corresponding to the intensity. The squelch voltage and the RSSI voltage are analog signals.

A GNSS module 6, a nonvolatile memory 7, a recording medium 8, the speaker 9, a display 10, a PTT (push to talk) switch 11, and an operation unit 12 are connected to the controller 1.

The GNSS module 6 includes: an antenna that receives a radio wave from a satellite for the global navigation satellite system (GNSS); and a reception unit that receives a GNSS signal to be outputted by the antenna. The GNSS is a GPS (global positioning system) as an example.

The GNSS module 6 acquires position information of the coordinates of the radio communication device 100, and supplies the acquired position information to the controller 1. The GNSS module 6 is a position information acquisition unit which acquires the position information for the subject station. The DSP 4 can add data, which indicates the position information, as the additional information, and can supply the data to the transceiver unit 2. In the event of transmitting the audio signal, the transceiver unit 2 may transmit the data, which indicates the position information for the subject station, in combination therewith.

The nonvolatile memory 7 stores a variety of setting states in the radio communication device 100. The nonvolatile memory 7 is, for example, an EEPROM (electrically erasable programmable read only memory).

The controller 1 can convert the analog audio signal (that is, a received audio signal), which is supplied by the DSP 4, into a digital audio signal, while the transceiver unit 2 receives the digital modulation signal. The controller 1 can record the digital audio signal as voice data (audio file) with a predetermined format in the recording medium 8. In addition to the received audio signal, the controller 1 may convert the analog audio signal (that is, a transmitted audio signal), which is outputted from the microphone 5, into a digital audio signal, while the transceiver unit 2 transmit the digital modulation signal. The controller 1 may record the digital audio signal as voice data in the recording medium 8.

The received audio signal mentioned herein is the analog audio signal supplied from the DSP 4 during the receiving operation, regardless of whether the received signal is present and modulated. The received audio signal may have no sound. The same also applies to the transmitted audio signal, which is the analog audio signal outputted from the microphone 5 during the transmitting operation. The transmitted audio signal may have no sound.

The recording medium 8 may be a recording medium built into the radio communication device 100, or may be a recording medium freely detachable from the radio communication device 100. In the latter case, as an example, the recording medium 8 is a memory card composed of a flash memory.

The controller 1 supplies the analog audio signal, which is supplied from the DSP 4, to the speaker 9. The controller 1 converts the voice data, which is reproduced from the recording medium 8, into the analog audio signal, and supplies the analog audio signal to the speaker 9. The speaker 9 performs electroacoustic conversion for the audio signal inputted thereto, and emits a sound.

The controller 1 can allow the display 10 to display a variety of information. For example, the controller 1 can allow the display 10 to display an operation setting menu image for setting the operation of the radio communication device 100. The operation setting menu image will be described later in detail.

In the event of reproducing the voice data recorded in the recording medium 8 (that is, recorded data), the controller 1 can allow display of a chapter selection image for selecting a position (chapter) to be reproduced. The chapter selection image will be described later in detail.

When the user speaks and transmits the audio signal, the user pushes the PTT switch 11. In a PTT-OFF state where the PTT switch 11 is not pushed, the PTT switch 11 supplies a HIGH voltage to the controller 1. In a PTT-ON state where the PTT switch 11 is pushed, the PTT switch 11 supplies a LOW voltage to the controller 1.

The controller 1 can determine the PTT-ON and PTT-OFF states by identifying LOW and HIGH voltage from the PTT switch 11.

For example, the operation unit 12 includes a variety of operation keys, a click encoder and an analog volume. The operation keys in the operation unit 12 are used in event of setting the operation of the radio communication device 100 by the operation setting menu image, and cue-reproducing the voice data by the chapter selection image.

Here, the operation unit 12 is described as one block; however, the operation keys, the click encoder and the analog volume may be provided at different positions in relation to one another.

In FIG. 1, blank arrows indicate a bus which connects the constituents to one another. There may be a case of using usual signal connection lines in place of the bus.

Note that, in a case of a digital modulation method, when the received signal is demodulated and decoded, the received signal becomes the received audio signal. Hereinafter, the matter that the received signal is converted into the received audio signal will be generically referred to as “demodulation” regardless of whether the modulation method is the digital modulation method or the analog modulation method. With regard to the transmission, in the case of the digital modulation method, when the transmitted audio signal is encoded and modulated, the transmitted audio signal becomes a transmitted signal, and the transmitted signal is transmitted. Hereinafter, the matter that the transmitted audio signal is converted into the transmitted signal will be generically referred to as “modulation” regardless of whether the modulation method is the digital modulation method or the analog modulation method.

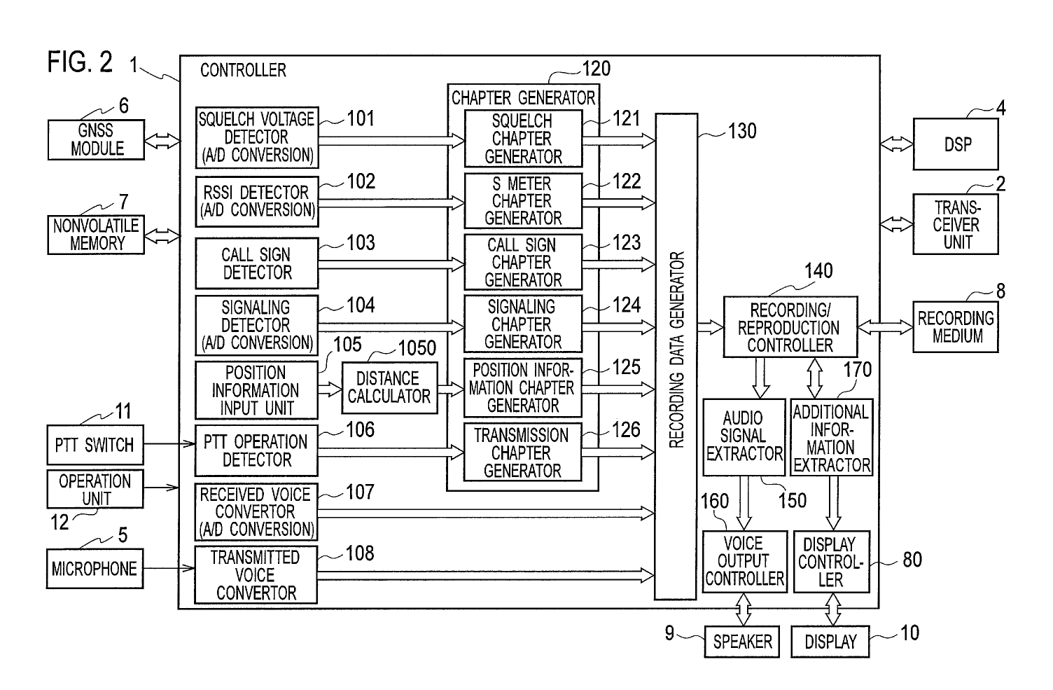

By using FIG. 2, a description is made of a specific internal configuration of the controller 1. As shown in FIG. 2, the controller 1 includes: a squelch voltage detector 101; an RSSI detector 102; a call sign detector 103; a signaling detector 104; a position information input unit 105; a PTT operation detector 106; a received voice converter 107; and a transmitted voice converter 108.

Each of the squelch voltage detector 101, the RSSI detector 102, the signaling detector 104, the received voice converter 107 and the transmitted voice converter 108 is provided with an A/D conversion function to convert the analog signal inputted thereto into the digital signal.

The controller 1 includes a distance calculator 1050 connected to the position information input unit 105. The controller 1 includes: a chapter generator 120; a recording data generator 130; and a recording/reproduction controller 140. In the recording/reproduction controller 140, a recording controller and a reproduction controller may be configured separately from one another.

The chapter generator 120 includes: a squelch chapter generator 121; an S meter chapter generator 122; a call sign chapter generator 123; a signaling chapter generator 124; a position information chapter generator 125; and a transmission chapter generator 126.

The chapter generator 120 does not have to provide the entire of the squelch chapter generator 121 to the transmission chapter generator 126. The chapter generator 120 may provide one or an arbitrary plurality, which is selected from the squelch chapter generator 121 to the transmission chapter generator 126.

Moreover, the controller 1 includes: an audio signal extractor 150; a voice output controller 160; an additional information extractor 170; and a display controller 180.

The radio communication device 100 generates a variety of chapters and records the chapters in the recording medium 8 at the time of recording the received audio signal, or recording both the received audio signal and the transmitted audio signal as the voice data.

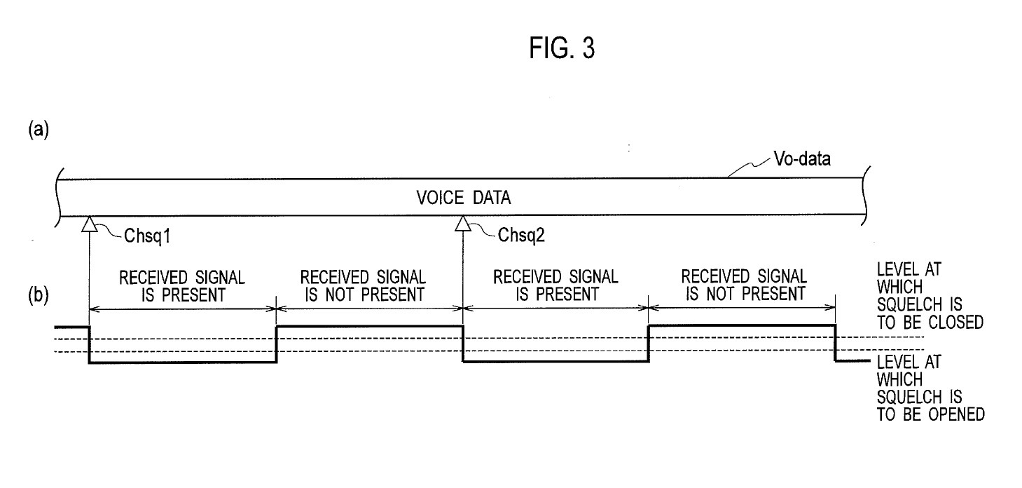

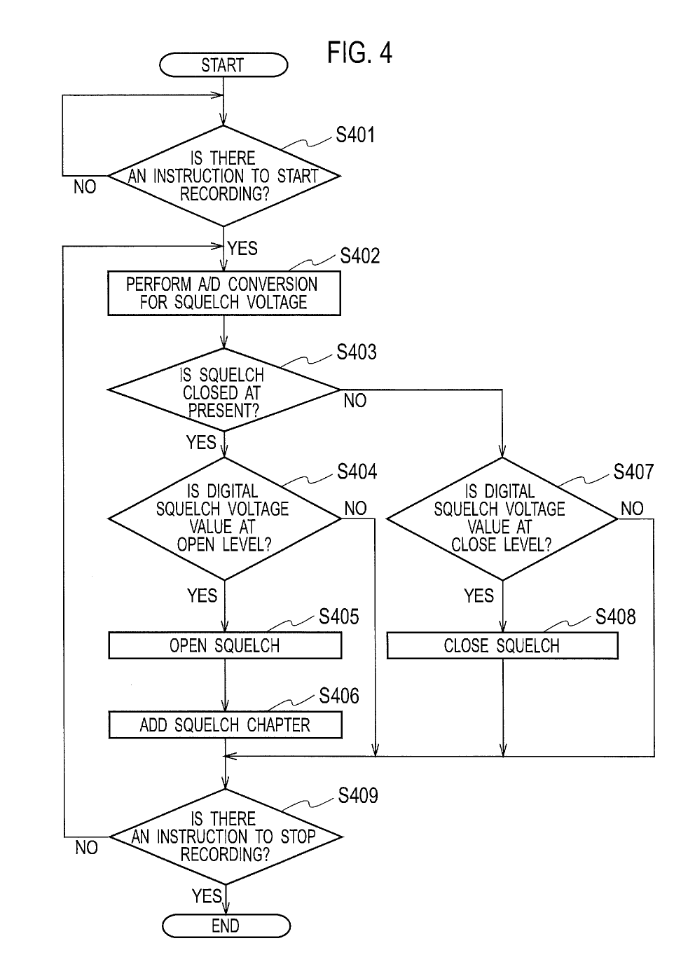

A schematic description is made of the individual chapters by using FIGS. 3, 5, 7, 9, 11 and 13. A description is made of pieces of processing in cases of adding the individual chapters to the voice data by using flowcharts shown in FIGS. 4, 6, 8, 9, 11 and 14.

(a) and (b) of FIG. 3 show a correspondence relationship between the state of the squelch and the squelch chapters. In FIG. 2, the squelch voltage detector 101 detects whether a current state is a so-called state where the squelch is closed, that is, the received signal is not present, or a so-called state where the squelch is opened, that is, the received signal is present based on the squelch voltage supplied from the squelch circuit 21.

It is assumed that the state of the squelch changes as shown in (b) of FIG. 3. As conceptually shown in (a) of FIG. 3, the chapter generator 121 generates squelch chapters Chsq1, Chesq2 . . . , which indicate timing when the state changes from the state where the received signal is not present to the state where the received signal is present. This means that the chapters are generated regardless of whether the received signal may be modulated.

The recording data generator 130 adds the squelch chapters Chsq1, Chesq2 . . . to voice data Vo-data to be recorded in the recording medium 8. The voice data Vo-data added with the squelch chapters Chsq1, Chesq2 . . . is recording data to be recorded in the recording medium 8.

If the squelch chapters are added to the voice data Vo-data, then there is an effect such that positions where such received signals are present can be selected and the recorded data can be reproduced.

By using the flowchart shown in FIG. 4, a description is made of processing for allowing the controller 1 to add the squelch chapters to the voice data Vo-data.

In FIG. 4, in step S401, the controller 1 determines whether or not an instruction to start the recording is issued by the operation unit 12. If the instruction to start the recording is issued (YES), the controller 1 executes next processing in the event of recording the voice data Vo-data in the recording medium 8.

In step S402, the controller 1 (squelch voltage detector 101) performs the A/D conversion for the squelch voltage. If the instruction to start the recording is not issued (NO), the controller 1 repeats the processing of step S401.

In step S403, the controller 1 determines whether or not the squelch is closed at present. The controller 1 shifts the processing to step S404 if the squelch is closed (YES), and shifts the processing to step S407 if the squelch is not closed (NO).

If the squelch is closed, the controller 1 determines in step S404 whether or not a digital squelch voltage value is at an open level. The controller 1 shifts the processing to step S405 if the digital squelch voltage value is at the open level (YES), and shifts the processing to step S409 if the digital squelch voltage value is not at the open level (NO).

In step S405, the controller 1 opens the squelch. In step S406, the controller 1 adds the squelch chapters to the voice data Vo-data, and shifts the processing to step S409.

Meanwhile, if the squelch is not closed, the controller 1 determines in step S407 whether or not the digital squelch voltage value is at a close level. If the digital squelch voltage value is at the close level (YES), the controller 1 closes the squelch in step S408, and shifts the processing to step S409. If the digital squelch voltage value is not at the close level (NO), the controller 1 shifts the processing to step S409.

In step S409, the controller 1 determines whether or not an instruction to stop the recording is issued by the operation unit 12. If the instruction to stop the recording is issued (YES), the controller 1 ends such processing for recording the voice data Vo-data in the recording medium 8. If the instruction to stop the recording is not issued (NO), the controller 1 returns the processing to step S402, and repeats the processing on and after step S402.

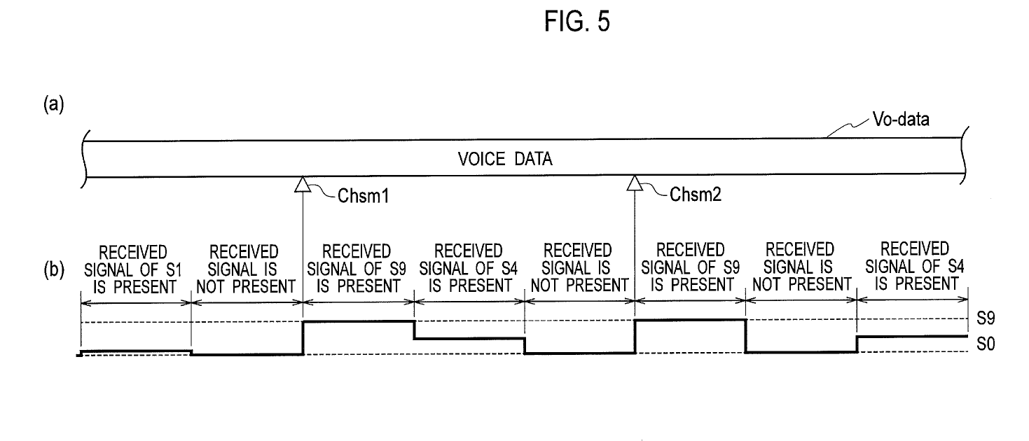

(a) and (b) of FIG. 5 show a correspondence relationship between a state of the S meter level and the S meter chapters. The RSSI detector 102 detects at which of S0 to S9 an S meter level is based on the RSSI voltage supplied from the RSSI circuit 22. S0 as an S meter level indicates that the signal intensity is 0 and that no received signal is present. S9 as an S meter level indicates a state where the signal intensity is highest.

Here, a description is made of, as an example, a case of generating the S meter chapters at a time when the S meter level is S9 and adding the generated S meter chapters to the voice data Vo-data. It is assumed that the S meter level changes between S0 to S9 as shown in (b) of FIG. 5. As conceptually shown in (a) of FIG. 5, the S meter chapter generator 122 generates the S meter chapters Chsm1, Chsm2 . . . , which indicate timing when the S meter level reaches S9.

The recording data generator 130 adds the S meter chapters Chsm1, Chsm2 . . . to the voice data Vo-data. If the S meter chapters are added to the voice data Vo-data, then there is an effect such that, for example, positions with high signal intensity, where the S meter level is at a predetermined level or more, can be selected and the recorded data can be reproduced.

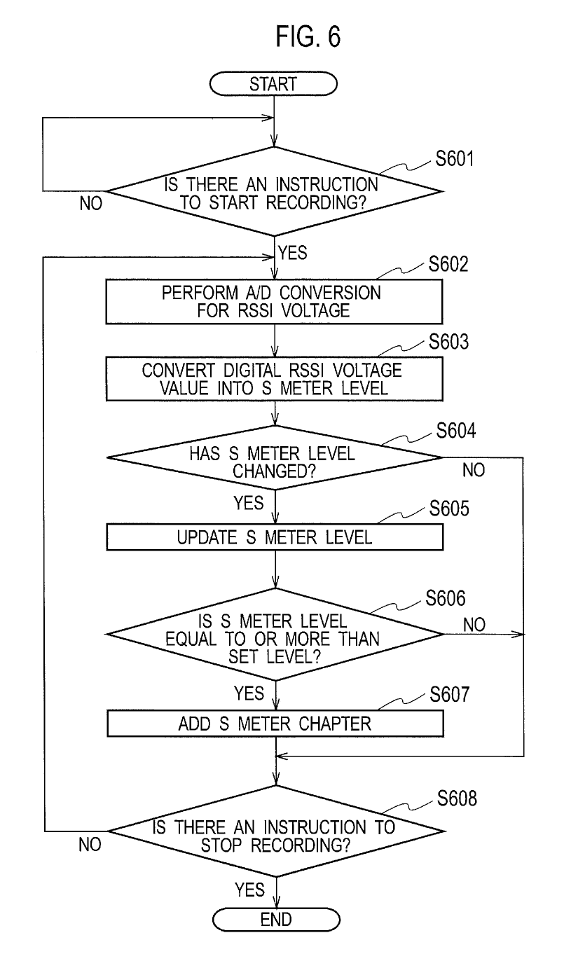

By using the flowchart in FIG. 6, a description is made of processing for allowing the controller 1 to add the S meter chapters to the voice data Vo-data.

In FIG. 6, in step S601, the controller 1 determines whether or not the instruction to start the recording is issued by the operation unit 12. If the instruction to start the recording is issued (YES), the controller 1 executes next processing in the event of recording the voice data Vo-data in the recording medium 8.

In step S602, the controller 1 (RSSI detector 102) performs the A/D conversion for the RSSI voltage. If the instruction to start the recording is not issued (NO), the controller 1 repeats the processing of step S601.

In step S603, the controller 1 converts a digital RSSI voltage value into the S meter level. In step S604, the controller 1 determines whether or not the S meter level has changed. The controller 1 shifts the processing to step S605 if the S meter level has changed (YES), and shifts the processing to step S608 if the S meter level has not changed (NO).

In step S605, the controller 1 updates the held S meter level. In step S606, the controller 1 determines whether or not the updated S meter level is a set level or more. The controller 1 shifts the processing to step S607 if the S meter level is the set level or more (YES), and shifts the processing to step S608 if the S meter level is not the set level or more (NO).

In step S607, the controller 1 adds the S meter chapters to the voice data Vo-data, and shifts the processing to step S608.

In step S608, the controller 1 determines whether or not the instruction to stop the recording is issued by the operation unit 12. If the instruction to stop the recording is issued (YES), the controller 1 ends the processing for recording the voice data Vo-data in the recording medium 8. If the instruction to stop the recording is not issued (NO), the controller 1 returns the processing to step S602, and repeats the processing on and after step S602.

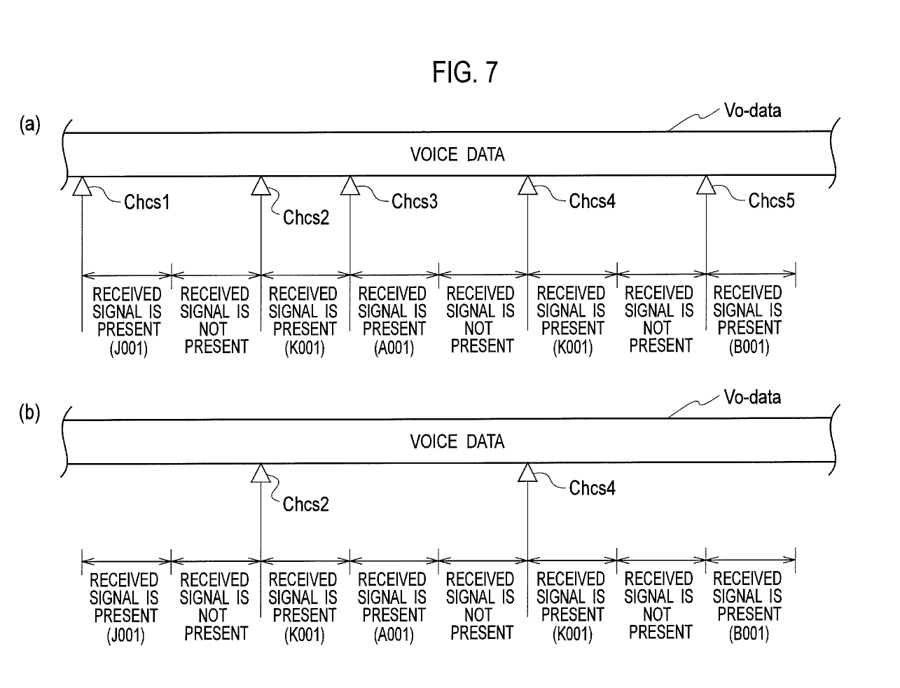

(a) and (b) of FIG. 7 show an example of adding call sign chapters to the voice data Vo-data. The call sign detector 103 detects the call sign of the distant station from a digital character string indicating the additional information supplied from the DSP 4. Since a position of the character string indicating the call sign of the distant station is determined in a voice packet, the call sign detector 103 can extract the call sign of the distant station based on the standard of the radio communication.

As an example, the standard of the radio communication is D-STAR (registered trademark) standardized by Japan Amateur Radio League. As a matter of course, the standard of the radio communication is not limited to D-STAR. Note that, in D-STAR, the call sign of the distant station is disposed in a header of a frame of the voice packet.

As conceptually shown in (a) of FIG. 7, the call sign chapter generator 123 can generate call sign chapters Chcs1, Chcs2, Chcs3, Chcs4, Chcs5 . . . , which indicate timing when the call sign of the distant station is switched.

As conceptually shown in (b) of FIG. 7, the call sign chapter generator 123 may generate the call sign chapters Chcs2, Chcs4, . . . , which indicate timing when the received signal is switched to a received signal of a call sign of a specific distant station. An example of (b) of FIG. 7 illustrates a case where a call sign K001 among call signs A001, B001, J001 and K001, which are shown in (a) of FIG. 7, is defined as the specific distant station.

The recording data generator 130 adds the call sign chapters Chcs1, Chcs2, Chcs3, Chcs4, Chcs5 . . . or Chcs2, Chcs4 . . . to the voice data Vo-data. If the call sign chapters are added to the voice data Vo-data, there is an effect such that the distant station can be selected and the recorded data can be reproduced.

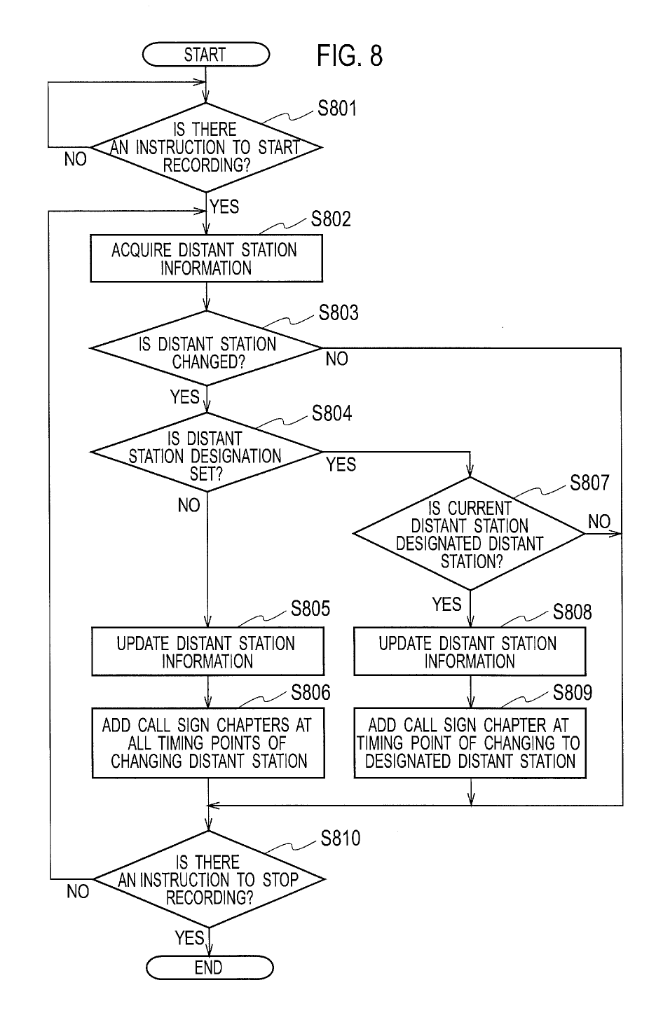

By using the flowchart shown in FIG. 8, a description is made of processing for allowing the controller 1 to add the call sign chapters to the voice data Vo-data.

In FIG. 8, in step S801, the controller 1 determines whether or not the instruction to start the recording is issued by the operation unit 12. If the instruction to start the recording is issued (YES), the controller 1 executes next processing in the event of recording the voice data Vo-data in the recording medium 8.

In step S802, the controller 1 (call sign detector 103) acquires distant station information. If the instruction to start the recording is not issued (NO), the controller 1 repeats the processing of step S801.

In step S803, the controller 1 determines whether or not the distant station is changed. The controller 1 shifts the processing to step S804 if the distant station is changed (YES), and shifts the processing to step S810 if the distant station is not changed (NO).

In step S804, the controller 1 determines whether or not setting of a distant station designation is made. The controller 1 shifts the processing to step S805 if the setting of the distant station designation is not made (NO), and shifts the processing to step S807 if the setting of the distant station designation is made (YES).

When the setting of the distant station designation is not made, the controller 1 updates the held distant station information in step S805. In step S806, the controller 1 adds the call sign chapters to the voice data Vo-data at all timing points when changing the distant stations, and shifts the processing to step S810.

(a) of FIG. 7 shows a state where the call sign chapters are added to the voice data Vo-data at all timing points when changing the distant stations in step S806.

Meanwhile, when the setting of the distant station designation is made, the controller 1 determines in step S807 whether or not a current distant station is a designated distant station. The controller 1 shifts the processing to step S808 if the current distant station is the designated distant station (YES), and shifts the processing to step S810 if the current distant station is not the designated distant station (NO).

In step S808, the controller 1 updates the held distant station information. In step S809, the controller 1 adds the call sign chapters to the voice data Vo-data at the timing point when changing to the designated distant station, and shifts the processing to step S810.

(b) of FIG. 7 shows a state where the call sign chapters are added to the voice data Vo-data at the timing point when changing to the designated distant station (here, the distant station having the call sign K001) in step S809.

In step S810, the controller 1 determines whether or not the instruction to stop the recording is issued by the operation unit 12. If the instruction to stop the recording is issued (YES), the controller 1 ends the processing for recording the voice data Vo-data in the recording medium 8. If the instruction to stop the recording is not issued (NO), the controller 1 returns the processing to step S802, and repeats the processing on and after step S802.

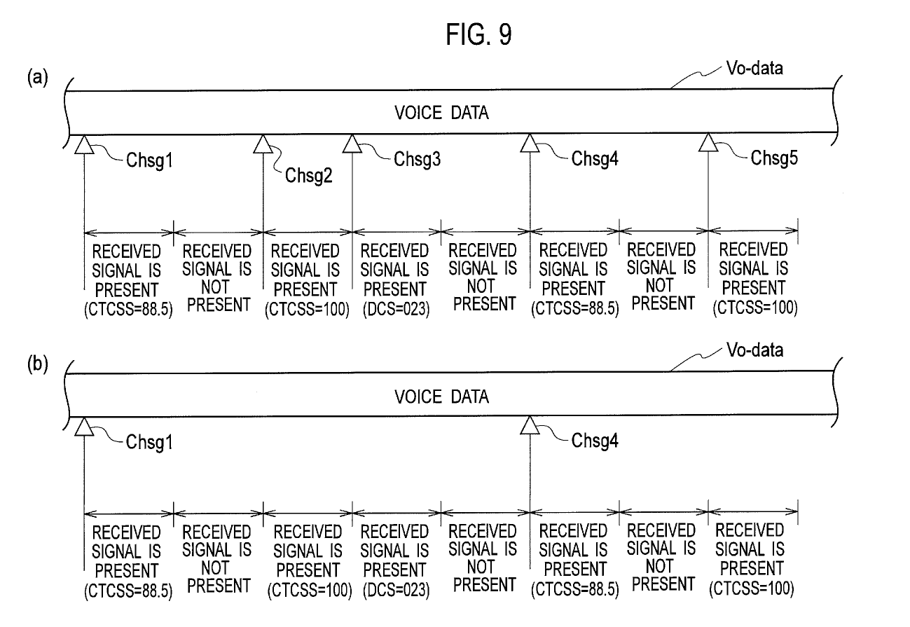

(a) and (b) of FIG. 9 show an example of adding signaling chapters to the voice data Vo-data. The signaling detector 104 detects signaling included in the received signal. The signaling is inherent information to be added to the received signal in order to limit members who perform radio communication only to specific members, and to make a group of members who perform transmission/reception.

In (a) of FIG. 9, CTCSS=88.5, CTCSS=100, DCS=023 and DCS=100 are examples of a signaling type. As conceptually shown in (a) of FIG. 9, the signaling chapter generator 124 can generate signaling chapters Chsg1, Chsg2, Chsg3, Chsg4, Chsg5 . . . , which indicate timing when the signaling is switched.

As conceptually shown in (b) of FIG. 9, the signaling chapter generator 124 may generate Chsg1, Chsg4 . . . , which indicate timing when the received signal is switched to a received signal with specific signaling. An example of (b) of FIG. 9 illustrates a case where the signaling CTCSS=88.5 among the signaling CTCSS=88.5, CTCSS=100, DCS=023 and DCS=100, shown in (a) of FIG. 9, is defined as the specific signaling.

If the signaling chapters are added to the voice data Vo-data, there is an effect such that the signaling can be selected and the recorded data can be reproduced.

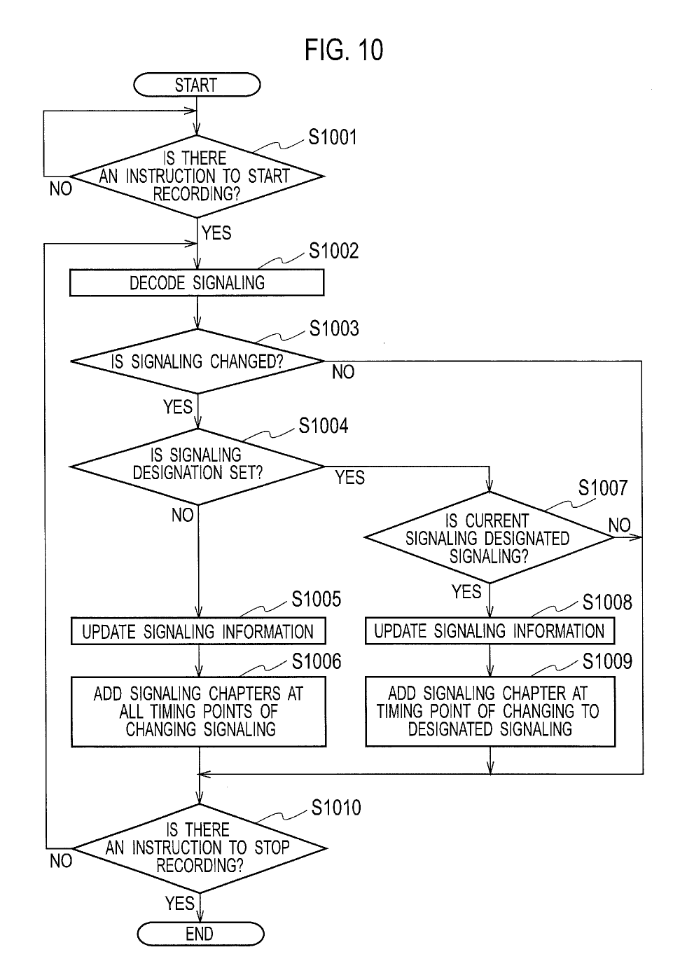

By using the flowchart in FIG. 10, a description is made of processing for allowing the controller 1 to add the signaling chapters to the voice data Vo-data.

In FIG. 10, in step S1001, the controller 1 determines whether or not the instruction to start the recording is issued by the operation unit 12. When the instruction to start the recording is issued (YES), the controller 1 executes next processing in the event of recording the voice data Vo-data in the recording medium 8.

In step S1002, the controller 1 (signaling detector 104) decodes the signaling. If the instruction to start the recording is not issued (NO), the controller 1 repeats the processing of step S1001.

In step S1003, the controller 1 determines whether or not the signaling is changed. The controller 1 shifts the processing to step S1004 if the signaling is changed (YES), and shifts the processing to step S1010 if the signaling is not changed (NO).

In step S1004, the controller 1 determines whether or not setting of signaling designation is made. The controller 1 shifts the processing to step S1005 if the setting of the signaling designation is not made (NO), and shifts the processing to step S1007 if the setting of the signaling designation is made (YES).

When the setting of the signaling designation is not made, the controller 1 updates the held signaling information in step S1005. In step S1006, the controller 1 adds the signaling chapters to the voice data Vo-data at all timing points when changing the signaling, and shifts the processing to step S1010.

(a) of FIG. 9 shows a state where the signaling chapters are added to the voice data Vo-data at all timing points when changing the signaling in step S1006.

Meanwhile, when the setting of the signaling designation is made, the controller 1 determines in step S1007 whether or not current signaling is the designated signaling. The controller 1 shifts the processing to step S1008 if the current signaling is the designated signaling (YES), and shifts the processing to step S1010 if the current signaling is not the designated signaling (NO).

In step S1008, the controller 1 updates the held signaling information. In step S1009, the controller 1 adds the signaling chapters to the voice data Vo-data at the timing point when changing the signaling to the designated signaling, and shifts the processing to step S1010.

(b) of FIG. 9 shows a state where the signaling chapters are added to the voice data Vo-data at the timing point when changing the signaling to the designated signaling (here, CTCSS=88.5) in step S1009.

In step S1010, the controller 1 determines whether or not the instruction to stop the recording is issued by the operation unit 12. When the instruction to stop the recording is issued (YES), the controller 1 ends such processing for recording the voice data Vo-data in the recording medium 8. If the instruction to stop the recording is not issued (NO), the controller 1 returns the processing to step S1002, and repeats the processing on and after step S1002.

Incidentally, the squelch chapters, the S meter chapters, the call sign chapters and the signaling chapters are examples of chapters (first chapters) which indicate timing when the state of the received signal has changed.

The squelch chapters and the S meter chapters are chapters which indicate the presence of the received signal and timing when the intensity thereof has changed as examples of the state of the received signal. The call sign chapters and the signaling chapters are chapters which indicate timing when the additional information included in the received signal has changed as another example of the state of the received signal.

The squelch voltage detector 101, the RSSI detector 102, the call sign detector 103 and the signaling detector 104 are examples of a detector (first detectors) which detects that the state of the received signal has changed.

The squelch chapter generator 121, the S meter chapter generator 122, the call sign chapter generator 123 and the signaling chapter generator 124 are examples of a first chapter generator which generates a first chapter.

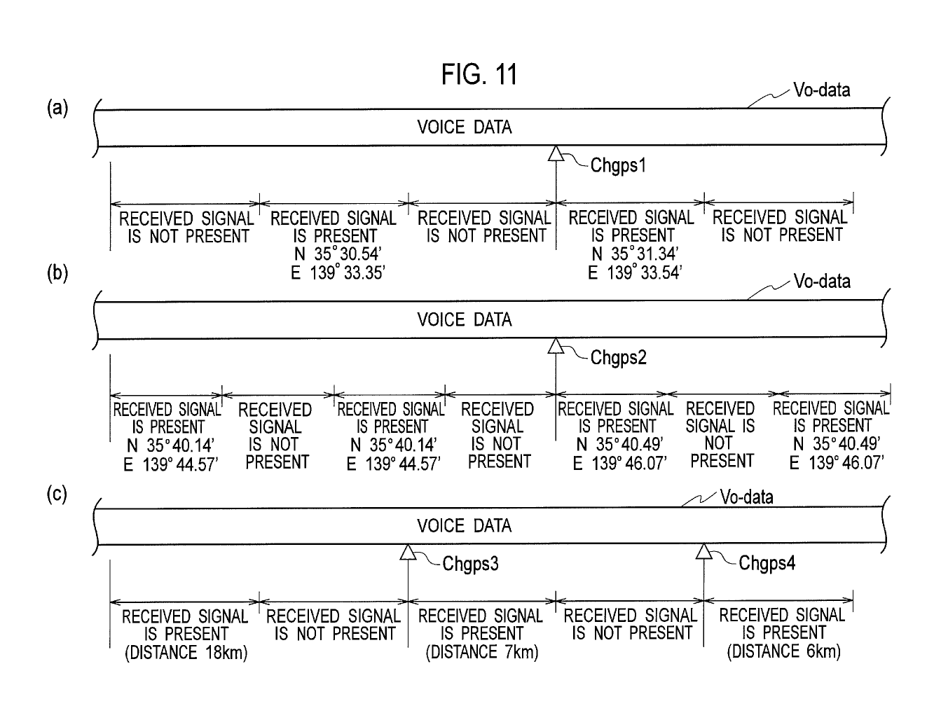

(a) to (c) of FIG. 11 show an example of adding position information chapters to the voice data Vo-data. To the position information input unit 105, the position information of the subject station is inputted from the GNSS module 6, and the position information of the distant station is inputted from the DSP 4. The position information of the subject station and the distant station is inputted to the distance calculator 1050.

The distance calculator 1050 can calculate the moving distance of a subject station based on variations of latitude/longitude indicated by the position information of the subject station. The distance calculator 1050 can calculate the moving distance of a distant station based on variations of latitude/longitude indicated by the position information of the distant station. The distance calculator 1050 can calculate the distance between a subject station and a distant station based on the latitude/longitude indicated by the position information of the subject station and the latitude/longitude indicated by the position information of the distant station.

North latitude denoted by N in (a) of FIG. 11 and east longitude denoted by E therein indicate the position information of the subject station. As conceptually shown in (a) of FIG. 11, if the subject station moves by a predetermined distance, the position information chapter generator 125 can generate position information chapters Chgps1 . . . . The predetermined distance is, for example, 10 km, and just needs to be appropriately set at 1 km, 5 km and the like.

North latitude denoted by N in (b) of FIG. 11 and east longitude denoted by E therein indicate the position information of the distant station. As conceptually shown in (b) of FIG. 11, if the distant station moves by a predetermined distance, the position information chapter generator 125 can generate position information chapters Chgps2 . . . .

(c) of FIG. 11 shows the distance between the subject station and the distant station. As conceptually shown in (c) of FIG. 11, when the distance between the subject station and the distant station is equal to or less than a predetermined distance, the position information chapter generator 125 can generate position information chapters Chgps3, Chgps4 . . . . The predetermined distance is, for example, 10 km, and just needs to be appropriately set.

The recording data generator 130 adds one of the position information chapters Chgps1 . . . , the position information chapters Chgps2 . . . or the position information chapters Chgps3, Chgps4 . . . to the voice data Vo-data. The recording data generator 130 may add an arbitrary combination of two of the position information chapters Chgps1 . . . , the position information chapters Chgps2 . . . , or the position information chapters Chgps3, Chgps4 . . . to the voice data Vo-data. The recording data generator 130 may add all of the position information chapters Chgps1 . . . , the position information chapters Chgps2 . . . and the position information chapters Chgps3, Chgps4 . . . to the voice data Vo-data.

If the position information chapters are added to the voice data Vo-data, there is an effect such that the recorded data can be reproduced from timing when the subject station or the distant station has moved.

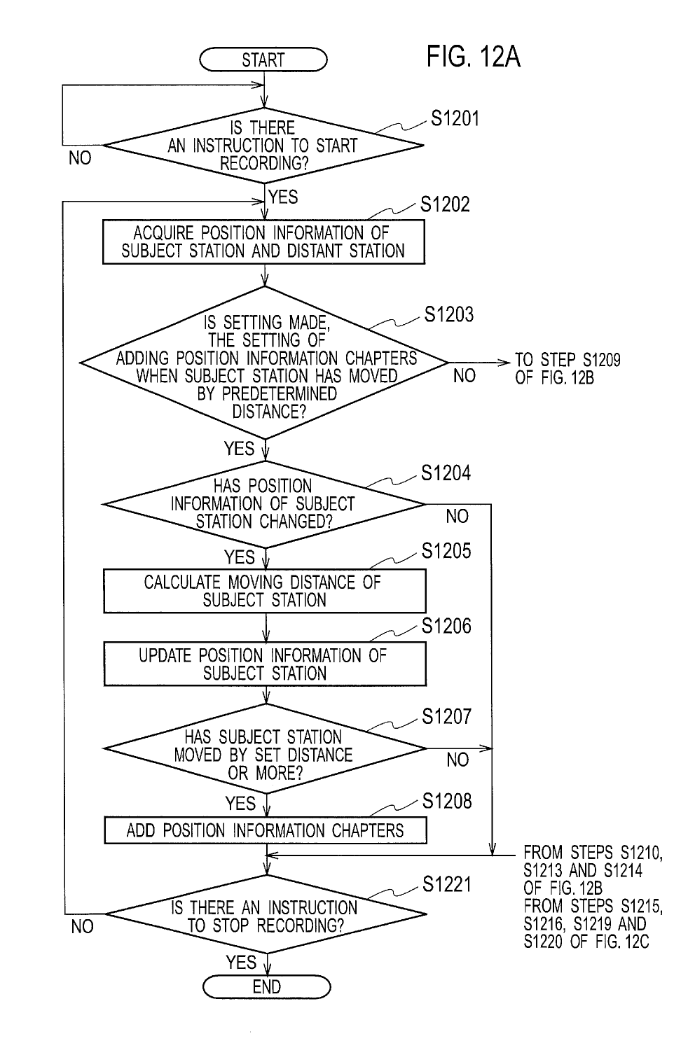

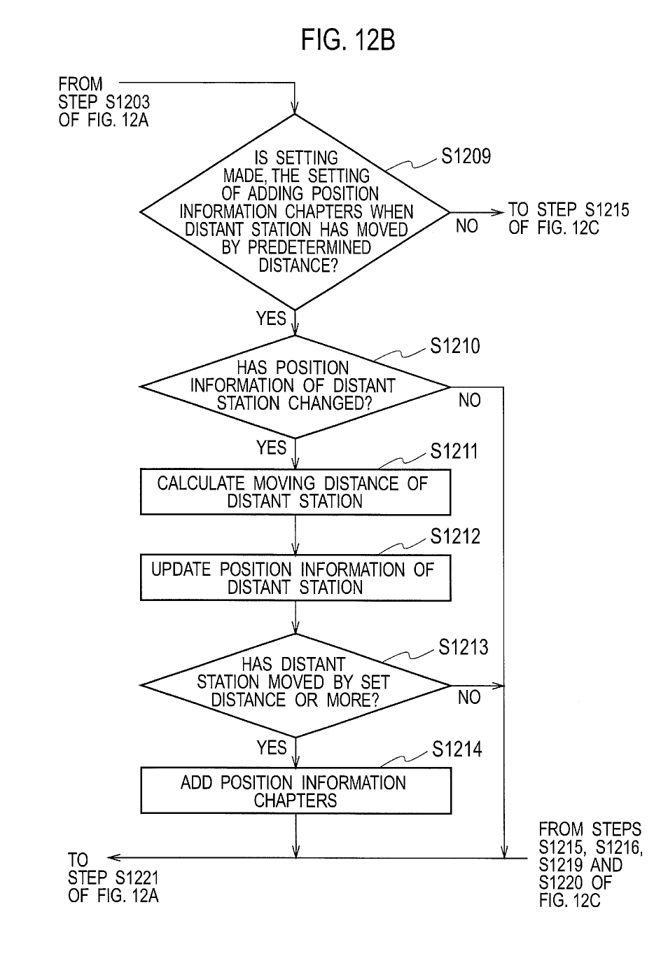

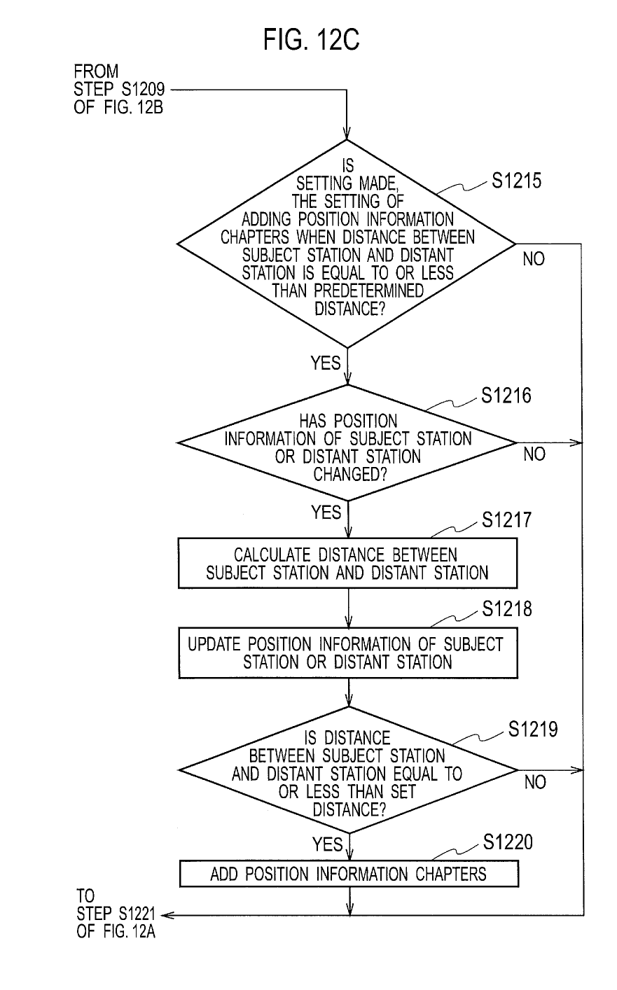

By using flowcharts of FIGS. 12A to 12C, a description is made of processing for allowing the controller 1 to add the position information chapters to the voice data Vo-data.

In FIG. 12A, in step S1201, the controller 1 determines whether or not the instruction to start the recording is issued by the operation unit 12. If the instruction to start the recording is issued (YES), the controller 1 executes next processing in the event of recording the voice data Vo-data in the recording medium 8.

In step S1202, the controller 1 (position information input unit 105) acquires the position information of the subject station and the distant station. If the instruction to start the recording is not issued (NO), the controller 1 repeats the processing of step S1201.

In step S1203, the controller 1 determines whether or not there is made setting of adding the position information chapters when the subject station has moved by the predetermined distance. The controller 1 shifts the processing to step S1204 if set to add the position information chapters when the subject station has moved by the predetermined distance (YES), and shifts the processing to step S1209 of FIG. 12B if the above-described setting is not made (NO).

In step S1204, the controller 1 determines whether or not the position information of the subject station has changed. The controller 1 shifts the processing to step S1205 if the position information of the subject station has changed (YES), and shifts the processing to step S1221 if the position information of the subject station has not changed (NO).

In step S1205, the controller 1 (distance calculator 1050) calculates the moving distance of the subject station. In step S1206, the controller 1 updates the position information of the subject station. In step S1207, the controller 1 determines whether or not the subject station has moved by the set distance or more. The controller 1 shifts the processing to step S1208 if the subject station has moved by the set distance or more (YES), and shifts the processing to step S1221 if the subject station has not moved by the set distance or more (NO).

In step S1208, the controller 1 adds the position information chapter, which indicates that the subject station has moved by the predetermined distance, to the voice data Vo-data, and shifts the processing to step S1221. (a) of FIG. 11 shows a state where the position information chapter, which indicates that the subject station has moved by the predetermined distance, is added to the voice data Vo-data in step S1208.

In FIG. 12B, in step S1209, the controller 1 determines whether or not a setting is made to add the position information chapters when the distant station has moved by the predetermined distance. The controller 1 shifts the processing to step S1210 if the setting to add the position information chapters when the distant station has moved by the predetermined distance (YES), and shifts the processing to step S1215 of FIG. 12C if the above-described setting is not made (NO).

In step S1210, the controller 1 determines whether or not the position information of the distant station has changed. The controller 1 shifts the processing to step S1211 if the position information of the distant station has changed (YES), and shifts the processing to step S1221 if the position information of the distant station has not changed (NO).

In step S1211, the controller 1 (distance calculator 1050) calculates the moving distance of the distant station. In step S1212, the controller 1 updates the position information of the distant station. In step S1213, the controller 1 determines whether or not the distant station has moved by the set distance or more. The controller 1 shifts the processing to step S1214 if the distant station has moved by the set distance or more (YES), and shifts the processing to step S1221 if the distant station has not moved by the set distance or more (NO).

In step S1214, the controller 1 adds the position information chapters which indicate that the distant station has moved by the predetermined distance, to the voice data Vo-data, and shifts the processing to step S1221. (b) of FIG. 11 shows a state where the position information chapter, which indicates that the distant station has moved by the predetermined distance, is added to the voice data Vo-data in step S1214.

In FIG. 12C, in step S1215, the controller 1 determines whether or not a setting is made to add the position information chapters when the distance between the subject station and the distant station is equal to or less than the predetermined distance. The controller 1 shifts the processing to step S1216 if a setting is made to add the position information chapters when the distance between the subject station and the distant station is equal to or less than the predetermined distance (YES), and shifts the processing to step S1221 if the above-described setting is not made (NO).

In step S1216, the controller 1 determines whether or not the position information of the subject station or the distant station has changed. The controller 1 shifts the processing to step S1217 if the position information of the subject station or the distant station has changed (YES), and shifts the processing to step S1221 if the position information of the subject station or the distant station has not changed (NO).

In step S1217, the controller 1 (distance calculator 1050) calculates the distance between the subject station and the distant station. In step S1218, the controller 1 updates the position information of the subject station or the distant station to the changed position information. In step S1219, the controller 1 determines whether or not the distance between the subject station and the distant station is equal to or less than the set predetermined distance.

The controller 1 shifts the processing to step S1220 if the distance between the subject station and the distant station is equal to or less than the predetermined distance (YES), and shifts the processing to step S1221 if the distance between the subject station and the distant station is not equal to or less than the predetermined distance (NO).

In step S1220, the controller 1 adds the position information chapters which indicate that the distance between the subject station and the distant station is equal to or less than the predetermined distance, to the voice data Vo-data, and shifts the processing to step S1221. (c) of FIG. 11 shows a state where the position information chapters, which indicate that the distance between the subject station and the distant station is equal to or less than the predetermined distance, is added to the voice data Vo-data in step S1220.

Returning to FIG. 12A, in step S1221, the controller 1 determines whether or not the instruction to stop the recording is issued by the operation unit 12. If the instruction to stop the recording is issued (YES), the controller 1 ends the processing for recording the voice data Vo-data in the recording medium 8. If the instruction to stop the recording is not issued (NO), the controller 1 returns the processing to step S1202, and repeats the processing on and after step S1202.

The position information chapters are examples of chapters (second chapters) which indicate timing when a predetermined condition is satisfied if at least one of the moving distance of the subject station, the moving distance of the distant station and the distance between the subject station and the distant station satisfies the predetermined condition.

The distance calculator 1050 is an example of a detector (second detector) which detects that at least one of the moving distance of the subject station, the moving distance of the distant station, or the distance between the subject station and the distant station, satisfies the predetermined condition. The position information chapter generator 125 is an example of a second chapter generator that generates the second chapters.

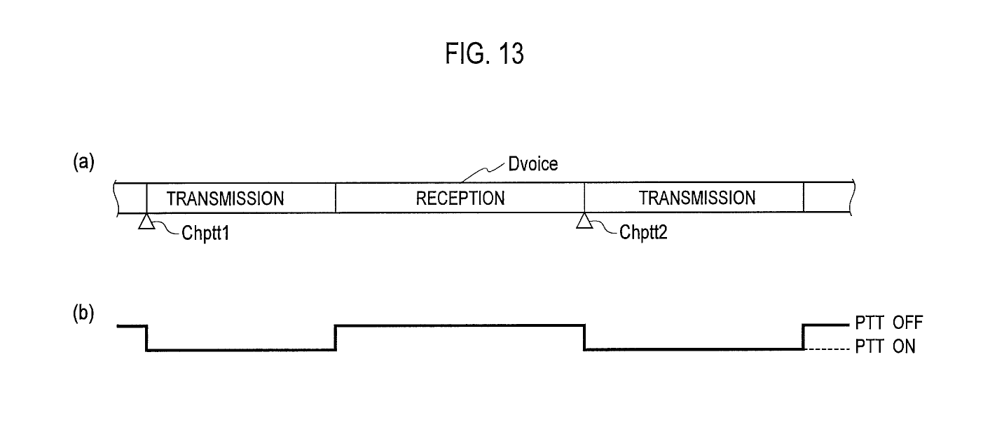

(a) and (b) of FIG. 13 show a correspondence relationship between a state of the PTT switch 11 and the transmission chapters. The PTT operation detector 106 detects whether or not the PTT switch 11 is operated. It is assumed that the PTT switch 11 is operated as shown in (b) of FIG. 13.

The voice data Vo-data is voice data converted from the received audio signal at a time of reception, and is voice data converted from the transmitted audio signal at a time of transmission.

As conceptually shown in (a) of FIG. 13, the transmission chapter generator 126 generates the transmission chapters Chptt1, Chptt2 . . . , which indicate timing when the PTT switch 11 is switched ON to set the transceiver unit 2 to a transmission state.

The recording data generator 130 adds the transmission chapters Chptt1, Chptt2 . . . to the voice data Vo-data.

In a case of recording the transmitted audio signal in the recording medium 8, the transmission chapter generator 126 generates the transmission chapters Chptt1, Chptt2 . . . , and the recording data generator 130 adds these to the voice data Vo-data. Since the communication method is half duplex, the transmission chapters may be added to the voice data Vo-data at the time of the transmission, and at the time of the reception, the above-mentioned variety of chapters addable at the time of the reception may be appropriately added thereto. In a case of recording only the received audio signal in the recording medium 8, the transmission chapter generator 126 just needs to be set inoperative.

If the transmission chapters are added to the voice data Vo-data, there is an effect such that a position as a transmission destination of the subject station can be selected and the recorded data can be reproduced.

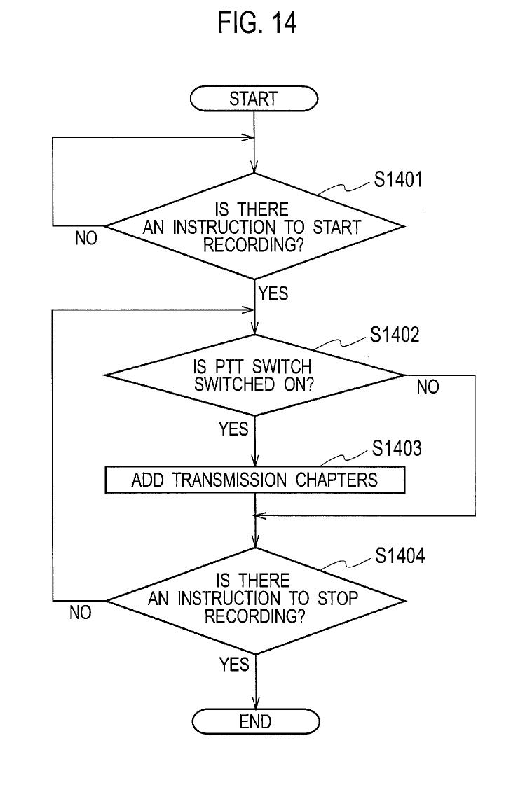

By using the flowchart in FIG. 14, a description is made of processing for allowing the controller 1 to add the transmission chapters to the voice data Vo-data.

In FIG. 14, in step S1401, the controller 1 determines whether or not the instruction to start the recording is issued by the operation unit 12. If the instruction to start the recording is issued (YES), the controller 1 executes next processing in the event of recording the voice data Vo-data in the recording medium 8.

In step S1402, the controller 1 (PTT operation detector 106) determines whether or not the PTT switch 11 is switched ON.

The controller 1 shifts the processing to step S1403 if the PTT switch 11 is switched ON (YES), and shifts the processing to step S1404 if the PTT switch 11 is not switched ON (NO). In step S1403, the controller adds the transmission chapters to the voice data Vo-data.

In step S1404, the controller 1 determines whether or not the instruction to stop the recording is issued by the operation unit 12. If the instruction to stop the recording is issued (YES), the controller 1 ends the processing for recording the voice data Vo-data in the recording medium 8. If the instruction to stop the recording is not issued (NO), the controller 1 returns the processing to step S1402, and repeats the processing on and after step S1402.

The transmission chapters are examples of chapters (third chapters) which indicate timing when the PTT switch 11 is pushed. The PTT operation detector 106 is an example of a detector (third detector) which detects that the PTT switch 11 is pushed and the transmission operation is performed by the transceiver unit 2. The transmission chapter generator 126 is an example of a third chapter generator that generates third chapters.

In FIG. 2, the received voice converter 107 converts the received audio signal, and supplies the received audio signal thus converted to the recording data generator 130. The transmitted voice converter 108 converts the transmitted audio signal, and supplies the transmitted audio signal thus converted to the recording data generator 130. The recording data generator 130 adds the variety of chapters described above to the voice data Vo-data which indicates the received audio signal or (the received audio signal and the transmitted audio signal), and generates the recorded data to be recorded in the recording medium 8.

The recording/reproduction controller 140 performs control to record the recorded data, which is generated by the recording data generator 130, in the recording medium 8. Moreover, the recording/reproduction controller 140 performs control to read and reproduce the recorded data, which is recorded in the recording medium 8.

Among the recorded data read from the recording medium 8 by the recording/reproduction controller 140, the digital audio signal as a portion of actual voice data is extracted by the audio signal extractor 150. The voice output controller 160 implements signal processing such as the D/A conversion for the digital audio signal, and allows the speaker 9 to emit a sound.

Among the recorded data read from the recording medium 8 by the recording/reproduction controller 140, the additional information added at the time of the recording, which is other than the voice data, is extracted by the additional information extractor 170. Based on the extracted additional information, the display controller 180 can allow the display 10 to display a chapter selection image for selecting a reproduction position in the voice data Vo-data.

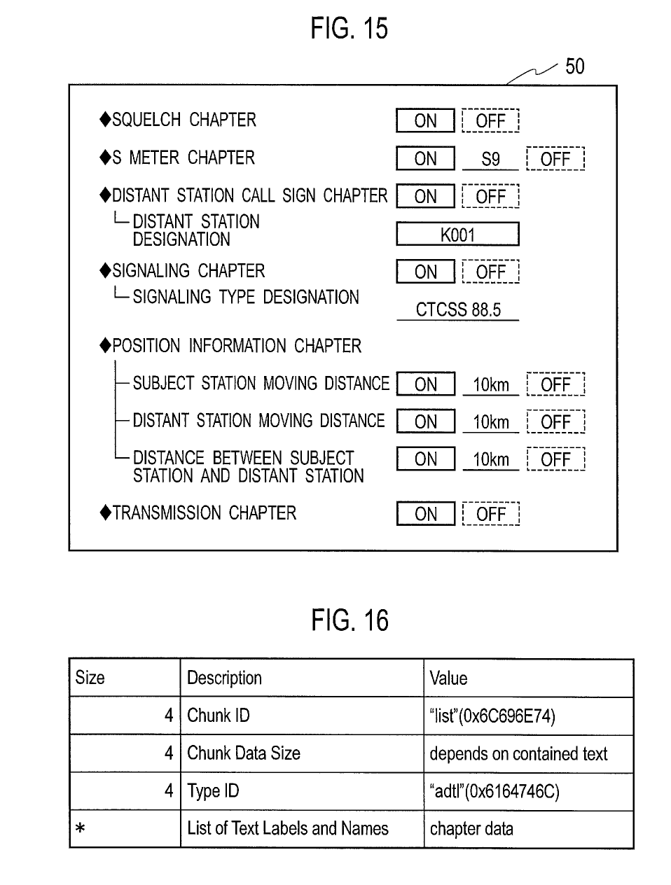

Here, by using FIG. 15, a description is made of an example of the operation setting menu image which the controller 1 allows the display 10 to display. An operation setting menu image 50 shown in FIG. 15 includes settings whether or not to set the squelch chapters, the S meter chapters, the call sign chapters, the signaling chapters, the position information chapters, and the transmission chapters. Here, an “ON” state is shown for all settings.

In the case of setting the chapters to “OFF” in any of the chapters, an item of the chapter concerned just needs to be selected by operating the operation unit 12, and the “OFF” setting just needs to be chosen.

Regarding the S meter chapter, the S meter level can be selected, and here, the S meter level is set at S9. In this case, the S meter chapters are added to the voice data Vo-data as shown in (a) of FIG. 5.

Regarding the call sign chapter, the call sign of the distant station can be designated, and here, the call sign is designated as “K001”. In this case, the call sign chapters are added to the voice data Vo-data as shown in (b) of FIG. 7.

Regarding the signaling chapter, the signaling type is designated as CTCSS=88.5. In this case, the signaling chapters are added to the voice data Vo-data as shown in (b) of FIG. 9.

Regarding the position information chapter, the setting is made so that the position information chapters are added to the voice data Vo-data when the subject station or the distant station has moved by 10 km or more, and the position information chapters are added to the voice data Vo-data when the distance between the subject station and the distant station has become equal to or less than 10 km. The distance here can be changed by the operation unit 12.

The settings for operations of the radio communication device 100, which are set by the operation setting menu image 50, are stored in the nonvolatile memory 7. Hence, the radio communication device 100 holds the settings stored in the nonvolatile memory 7.

Next, a description is made of an example of a file format of the recorded data to be generated by the recording data generator 130, and of away of adding the chapters to the voice data.

In the embodiment, it is assumed that the file format of the recorded data is a WAVE file (WAV format). In the embodiment, it is assumed that chapter information is included in a list chunk defined by the WAVE file. The file format is not limited to the WAVE file.

FIG. 16 shows a format of the list chunk. The list chunk includes a chunk ID, a chunk data size and a type ID, each size of which is 4 bytes. The chunk ID is “list”, and the type ID is “adt1”.

The recording data generator 130 stores the chapter information (chapter data) in the list region of the list chunk (list of text labels and names).

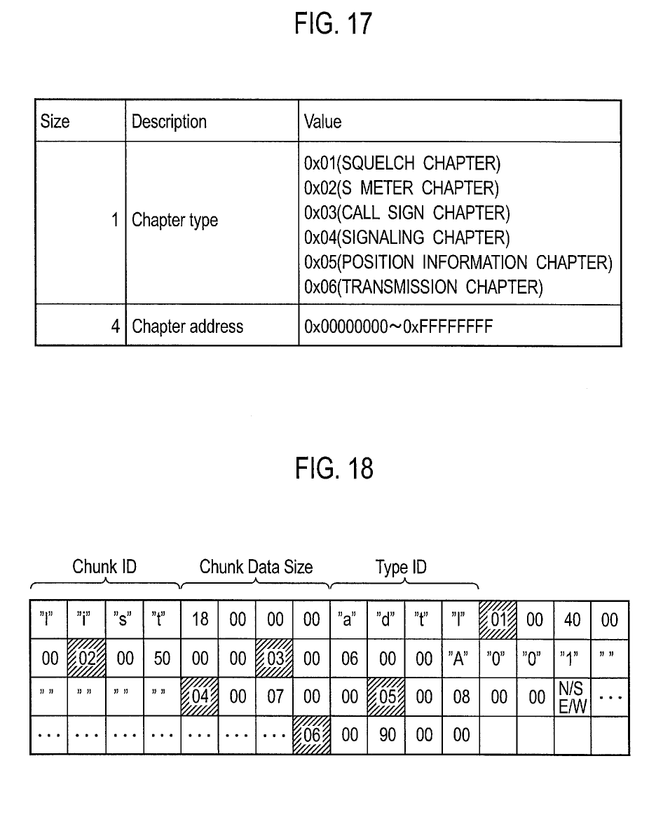

As an example, the information of such a chapter, which is to be stored in the list region, can be summarized into a format shown in FIG. 17. As shown in FIG. 17, the information of the chapter includes 1-byte chapter type and 4-byte chapter address.

0× in each value of the chapter type and the chapter address in FIG. 17 indicates that the value is hexadecimal. As examples, the chapter type “01” indicates the squelch chapter, the chapter type “02” indicates the S-meter chapter, and the chapter type “03” indicates the call sign chapter. The chapter type “04” indicates the signaling chapter, the chapter type “05” indicates the position information chapter, and the chapter type “06” indicates the transmission chapter.

The chapter address indicates any value within a range from 00000000 to FFFFFFFF. The chapter address is position information that indicates at which position of the voice data Vo-data each of the chapters conceptually shown in FIGS. 3, 5, 7, 9, 11 and 13 is located.

By using FIG. 18, a description is made of a specific example of the list chunk. Each section in FIG. 18 is 1-byte of data. As shown in FIG. 18, the first 4 bytes indicate the chunk ID, the next 4 bytes indicate the chunk data size, and the next 4 bytes indicate the type ID.

The hatched 1-byte of data (the hatching is for facilitating the understanding of the data) indicates the chapter type. 4-byte “00400000” subsequent to the chapter type “01” indicates the chapter address of the squelch chapter. 4-byte “00500000” subsequent to the chapter type “02” indicates the chapter address of the S meter chapter.

4-byte “00600000” subsequent to the chapter type “03” indicates the chapter address of the call sign chapter. 9 bytes subsequent to the chapter address of the call sign chapter are ensured as a region that indicates the call sign. Here, the call sign is set as “A001”.

4-byte “00700000” subsequent to the chapter type “04” indicates the chapter address of the signaling chapter. 4-byte “00800000” subsequent to the chapter type “05” indicates the chapter address of the position information chapter. 9 bytes subsequent to the chapter address of the position information chapter are ensured as a region that indicates the position information.

The first 1 byte of the region which indicates the position information indicates either north or south latitude (N/S), and either east or west longitude (E/W). The remaining 8 bytes of the region which indicates the position information are assigned to 4-byte latitude and 4-byte longitude. The order of the longitude and the latitude is predetermined.

The number of bytes, which should be assigned to both the region that indicates the call sign and the region that indicates the position information, just needs to be appropriately set. Hence, the number of bytes is not limited to 9 bytes.

4-byte “00900000” subsequent to the chapter type “06” indicates the chapter address of the transmission chapter.

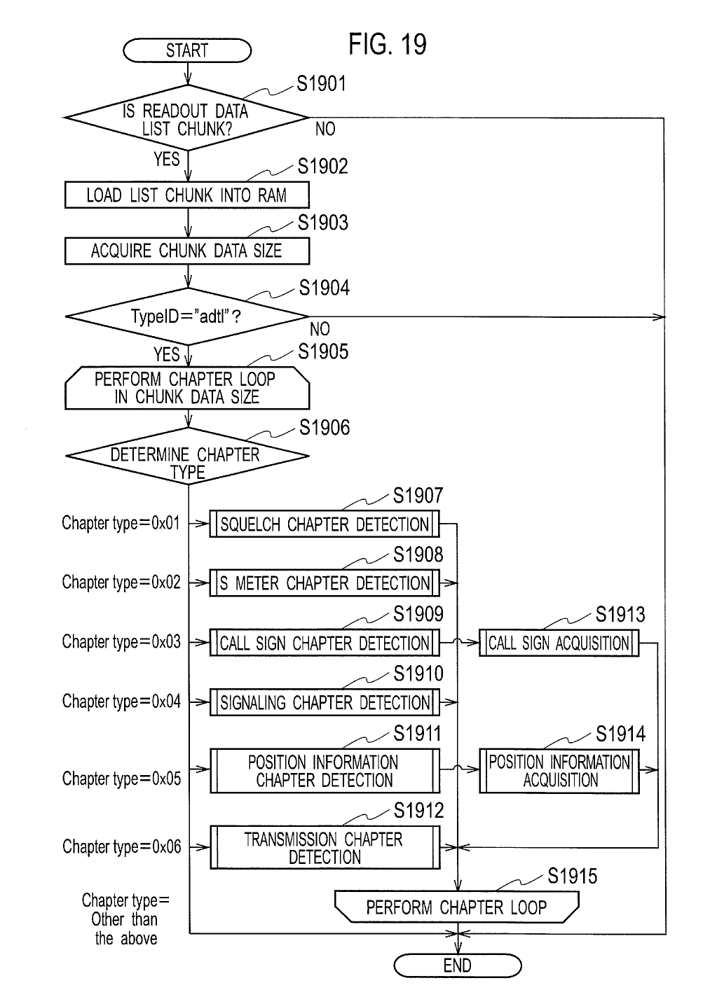

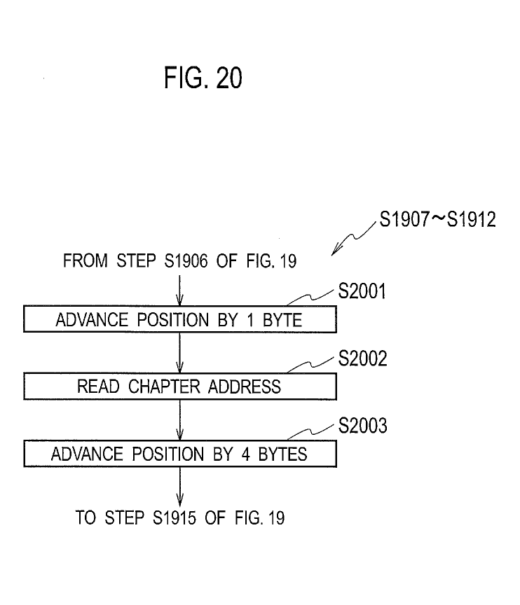

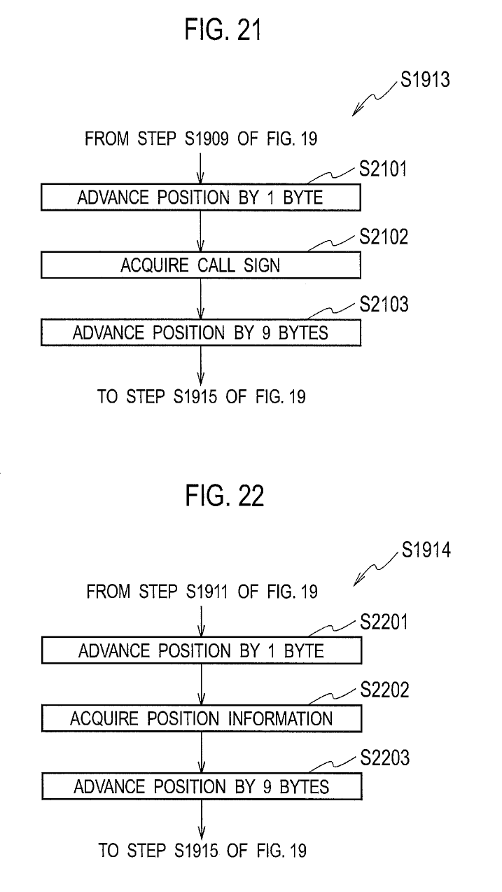

FIG. 19 is a flowchart showing processing for reading information regarding the chapters from the list chunk of the WAVE files. In FIG. 19, in step S1901, the controller 1 (additional information extractor 170) determines whether or not the readout data is the list chunk based on whether or not the chunk ID is “list”. The controller 1 shifts the processing to step S1902 if the readout data is the list chunk (YES), and ends the processing if the readout data is not the list chunk (NO).

In step S1902, the controller 1 loads the data of the list chunk into a RAM (not shown) in the controller 1. In step S1903, the controller 1 acquires the chunk data size. In step S1904, the controller 1 determines whether or not the type ID is “adt1”. The controller 1 shifts the processing to step S1905 if the type ID is “adt1” (YES), and ends the processing if the type ID is not “adt1” (NO).

In step S1905, the controller 1 executes processing of a chapter loop, which will be described below, within the chunk data size. In step S1906, the controller 1 determines the chapter type.

If the chapter type is “01”, then in step S1907, the controller 1 detects the squelch chapter, and shifts the processing to step S1915. If the chapter type is “02”, then in step S1908, the controller 1 detects the S meter chapter, and shifts the processing to step S1915.

If the chapter type is “03”, then the controller 1 detects the call sign chapter in step S1909, acquires the call sign in step S1913, and shifts the processing to step S1915.

If the chapter type is “04”, then in step S1910, the controller 1 detects the signaling chapter, and shifts the processing to step S1915. If the chapter type is “05”, then the controller 1 detects the position information chapter in step S1911, acquires the position information in step S1914, and shifts the processing to step S1915.

If the chapter type is “06”, then in step S1912, the controller 1 detects the transmission chapter, and shifts the processing to step S1915. If the chapter type is not any of “01” to “06”, the controller 1 ends the processing.

In step S1915, the controller 1 executes the chapter loop of steps S1906 to S1914, and accordingly, can read the information regarding all of the chapters, which is written in the list chunk.

Specifically, each of steps S1907 to S1912 of FIG. 19 includes steps shown in FIG. 20. In FIG. 20, in step S2001, the controller 1 advances the position of the readout data by 1 byte. In such a way, the position of the readout data can be set to the position of the chapter address next to the chapter type hatched in FIG. 18.

In step S2002, the controller 1 reads the 4-byte chapter address. In step S2003, the controller 1 advances the position of the data, which is to be read, by 4 bytes. In such a way, the controller 1 can set the position of the data, which is to be read, to the position of the next data.

Step S1913 of FIG. 19 specifically includes steps shown in FIG. 21. In FIG. 21, in step S2101, the controller 1 advances the position of the data, which is to be read, by 1 byte. In step S2102, the controller 1 reads the 9-byte call sign. In step S2103, the controller 1 advances the position of the data, which is to be read, by 9 bytes.

Step S1914 of FIG. 19 specifically includes steps shown in FIG. 22. In FIG. 22, in step S2201, the controller 1 advances the position of the data, which is to be read, by 1 byte. In step S2202, the controller 1 reads the 9-byte position information. In step S2203, the controller 1 advances the position of the data, which is to be read, by 9 bytes.

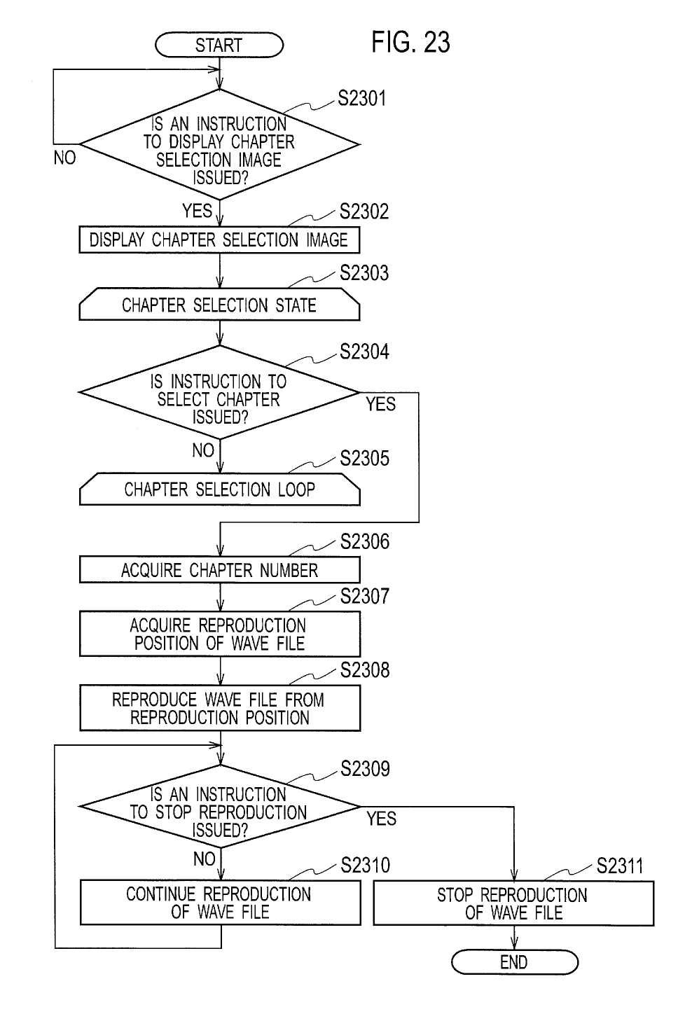

By using the flowchart shown in FIG. 23, a description is made of processing for selecting the chapter and cueing the predetermined position of the voice data.

In step S2301, the controller 1 determines whether or not an instruction to display the chapter selection image is issued by the operation unit 12. The controller 1 shifts the processing to step S2302 if the instruction to display the chapter selection image is issued (YES), and repeats the processing of step S2301 if the instruction to display the chapter selection image is not issued (NO).

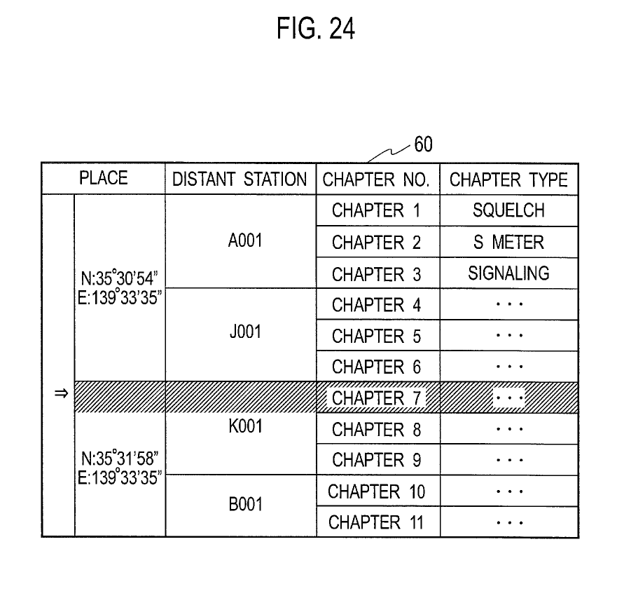

In step S2302, the controller 1 allows the display 10 to display the chapter selection image. FIG. 24 shows a chapter selection image 60 as an example of the chapter selection image. The chapter selection image 60 is an image in which the position information of the subject station, the call sign of the distant station, the chapter number and the chapter type are arrayed in a listed table format.

In addition to the position information of the subject station, the position information of the distant station may be displayed on the chapter selection image 60. In place of the position information of the subject station, the position information of the distant station may be displayed on the chapter selection image 60. Which item should be displayed on the chapter selection image just needs to be appropriately set.

The chapter number shown in the chapter selection image 60 includes serial numbers 1, 2, 3 . . . , which are assigned in an ascending order to the plurality of chapters added to the voice data Vo-data.

It is assumed that, for example, a user's house is located at lat. 35° 30′54″ N. and long. 139° 33′35″ E., which are the position information of the subject station shown in the chapter selection image 60. If lat. 35° 30′54″ N. and long. 139° 33′ 35″ E. are registered as the location of the user's house (subject house) in the nonvolatile memory 7, then it is also possible to display “subject house” in the place column shown in the chapter selection image 60.

The recording/reproduction controller 140 reads the list chunk data in the WAVE file, which is stored in the recording medium 8. The additional information extractor 170 extracts the information regarding the chapters in such a manner as shown in FIG. 19. Hence, the display controller 180 can allow the display 10 to display the chapter selection image 60.

The controller 1 sets an operation state thereof to a chapter selection state in step S2303, and determines in step S2304 whether or not an instruction to select the chapter is issued. If the instruction to select the chapter is not issued (NO), the controller 1 executes the loop of the chapter selection in step S2305.

If the instruction to select the chapter is issued (YES), the controller 1 acquires the chapter number in step S2306. FIG. 24 shows a state where the chapter 7 is selected.

In step S2307, the controller 1 acquires a reproduction position of the WAVE file based on the chapter address owned by the chapter that indicates the selected chapter number. In step S2308, the controller 1 reproduces the WAVE file from the reproduction position.

In step S2309, the controller 1 determines whether or not an instruction to stop the reproduction is issued by the operation unit 12. If the instruction to stop the reproduction is not issued (NO), then in step S2310, the controller 1 continues the reproduction of the wave file, and returns the processing to step S2309. If the instruction to stop the reproduction is issued (YES), then in step S2311, the controller 1 stops the reproduction of the WAVE file, and ends the processing.

FIG. 23 shows processing in a case of selecting the chapter and reproducing the WAVE file from a state where the wave file is not reproduced. In the state where the WAVE file is reproduced, it is also possible to cue the reproduction position by allowing the display 10 to display the chapter selection image 60 and selecting the chapter.

Incidentally, besides allowing the list chunk of the WAVE file to include the information of the chapter, the file name of the audio file may be allowed to include the information regarding the chapter.

For example, the file name can be allowed to include the information regarding the chapter in the format of “CHHMMSS”. C denotes the type of chapter, HH denotes the hour, MM denotes the minutes, and SS denotes the seconds. It is assumed that Q would be the squelch chapter, M would be the S meter chapter, C would be the call sign chapter, S would be the signaling chapter, G would be the position information chapter, and T would be the transmission chapter.

As an example, the file name is 20141020_Q001015C002203G010534.wav. Leading with 20141020 indicates that the WAVE file is recorded in Oct. 20, 2014. A time may be added to the recorded date.

Q001015 indicates that the squelch chapter is located at a timing after the elapse of 10 minutes and 15 seconds from the head of the audio file. C002203 indicates that the call sign chapter is located at a timing after the elapse of 22 minutes and 3 seconds from the head of the audio file. G010534 indicates that the position information chapter is located at a timing after the elapse of 1 hour, 5 minutes and 34 seconds from the head of the audio file.

Here, the file name of the WAVE file is exemplified; however, the file name can be allowed to include the information regarding the chapters in a similar way to an audio file with another format. Note that, since the data size of the file name is not very large, it is preferable to record the information regarding the chapters as such additional information as the list chunk.

As described above, in accordance with the radio communication device of the embodiment, the predetermined position of the recorded audio signal can be cued with ease when the audio signal is reproduced.

The present invention is not limited to the embodiment described above, and is changeable in various ways within the scope without departing from the scope of the present invention In the configuration shown in FIG. 1, the choice of hardware and software is arbitrary.

What is claimed is:

1. A radio communication device comprising:
a reception unit configured to demodulate a received audio signal from a received signal;
a first detector configured to detect that a state of the received signal has changed when the reception unit receives a signal transmitted wirelessly from a distant station;
a first chapter generator configured to generate a first chapter when the first detector has detected that the state of the received signal has changed, the first chapter indicating timing when the state of the received signal has changed;
a recording data generator configured to convert the received audio signal into voice data with a predetermined format, add the first chapter to the voice data, and generate recording data with a predetermined format; and
a recording controller configured to control to record the recording data in a recording medium.

2. The radio communication device according to claim 1, further comprising:
a first position information acquisition unit configured to acquire position information of a subject station;
a second position information acquisition unit configured to acquire position information of the distant station;
a second detector configured to detect that at least one of a first moving distance of the subject station, the first moving distance being calculated from the position information of the subject station, a second moving distance of the distant station, the second moving distance being calculated from the position information of the distant station, or a distance between the subject station and the distant station, the distance being calculated from the position information of the subject station and the position information of the distant station, satisfies a predetermined condition; and
a second chapter generator configured to generate a second chapter when at least one of the first moving distance, the second moving distance, or the distance between the subject station and the distant station, satisfies the predetermined condition, the second chapter indicating timing when the predetermined condition is satisfied,
wherein the recording data generator is configured to add the second chapter to the voice data, and generate the recording data.

3. The radio communication device according to claim 1, further comprising:
a transmission unit configured to wirelessly transmit a transmitting audio signal of a subject station to the distant station;
a PTT switch;
a third detector configured to detect that the PTT switch is pushed, and that an operation of transmitting the transmitting audio signal is performed by the transmission unit; and
a third chapter generator configured to generate a third chapter that indicates timing when the PTT switch is pushed,
wherein the recording data generator configured to convert the transmitting audio signal into the voice data, add the third chapter to the voice data, and generate the recording data.

4. The radio communication device according to claim 1, wherein the first detector is configured to detect, as a change of the state of the received signal, at least one of a change of a squelch that has turned from a closed state to an opened state, a change of an S meter that has turned from a state of less than a predetermined value to the predetermined value, a change of a call sign of the distant station, the call sign being included in the received signal, or a change of signaling included in the received signal.

5. The radio communication device according to claim 1, wherein the first detector is configured to detect, as a change of the state of the received signal, at least one of a case where a call sign of the distant station included in the received signal is changed from a call sign other than a specific call sign to the specific call sign, or a case of where signaling included in the received signal is changed from a signaling other than a specific signaling to the specific signaling.

6. The radio communication device according to claim 1, wherein the recording data generator is configured to generate a WAVE file as the recording data with the predetermined format, and record a chapter address in a list chunk of the WAVE file, the chapter address indicating a position of the first chapter in the voice data.

7. The radio communication device according to claim 1, further comprising:
a reproduction controller configured to control to reproduce the recording data recorded in the recording medium;
an additional information extractor configured to extract the first chapter from the recording data;
a display controller configured to control to generate a chapter selection image in which a plurality of the first chapters extracted by the additional information extractor is listed, and to display the generated chapter selection image on a display; and
an operation unit configured to select any of the first chapters included in the chapter selection image,
wherein the reproduction controller controls to reproduce the recording data from a position indicated by the selected first chapter when any of the first chapters is selected by the operation unit.
